(19) United States
(12) Patent Application Publication
(10) Pub. No.: US 2005/0066742 A1
(43) Pub. Date: Mar. 31, 2005

(54) Capacitive dynamometer

(76) Inventor: Nils Aage Juul Eilersen, Vedbaek (DK)

Correspondence Address: Eilersen Nils Aage Juul, Goengehusvej 226, Vedbaek, DK-2950, DK

(21) Appl. No.: 10/476,932

(22) PCT Filed: Mar. 27, 2002
(86) PCT No.: PCT/DK02/00219

(30) Foreign Application Priority Data
Mar. 27, 2001 (DK) 2001 00509
Oct. 5, 2001 (DK) 2001 01459

(51) Int. Cl. G01N 3/20

(52) U.S. Cl. 73/849

(57) ABSTRACT

The invention relates to a capacitive dynamometer comprising an elastic body for receiving a mechanical force to be measured, the body having a measuring cavity, which is deformed, when the mechanical force to be measured is applied to the elastic body, the deformations of the inner wall of the cavity being picked up in the form of changes of capacity by means of capacitor electrodes co-operating with the inner wall. The invention is characterized in that said elastic body includes a flexible tube having a length which is substantially larger than the height of said tube, said tube having solid ends and measuring means, adapted for measuring a displacement between said solid ends of said flexible tube, utilizing a cavity of said flexible tube adapted to performing or transferring the displacement measurement.

The invention relates to a capacitive dynamometer comprising an elastic body for receiving a mechanical force to be measured, the body having a measuring cavity, which is deformed, when the mechanical force to be measured is applied to the elastic body, the deformations of the inner wall of the cavity being picked up in the form of changes of capacity by means of capacitor electrodes co-operating with the inner wall.

From EP A 0.108.894 a torsion measuring device is known where capacitor electrodes are arranged in an elastic tube to detect the relative angular displacement of the ends of an elastic tube when a torsion is applied to the measuring device. This measuring device is specifically designed to be insensitive to bending forces.

From U.S. Pat. No. 4,175,428 a capacitive dynamometer of the kind referred to is known comprising an elastic body with a measuring cavity, which is deformed when a mechanical force to be measured is applied to the elastic body.

In this known dynamometer the cavity has to be of appreciable dimensions in order for the measured force to produce the dimensional changes that are necessary for the capacitance of the capacitor electrodes to change enough to be measured accurately. As the elastic body is normally of steel and the electrode carrier is normally fabricated in a ceramic material with thick-film electrodes, the necessary large dimensions in connection with a rather high difference in coefficient of thermal expansion between steel and ceramics gives problems with measuring accuracy by varying temperature of the dynamometer.

Furthermore when the cavity is cylindrical with the measured force changing the cross section the whole length of the cavity, the necessary closure of the ends of the cavity against the environment has to be elastic and rather flexible in the form of a membrane or bellow in order not to influence the measurement.

It is the object of the invention to provide an improved capacitive dynamometer of the type initially mentioned.

According to the invention this object is achieved by a measuring device of the abovementioned type characterized in that said elastic body includes a flexible tube having a length which is substantially larger than the height of said tube, said tube having solid ends and measuring means, adapted for measuring a displacement between said solid ends of said flexible tube, utilizing a cavity of said flexible tube adapted to performing or transferring the displacement measurement.

Measuring cavities in the flexible tube and or in the solid ends or in extensions of the solid ends includes preferably an elongated electrode carrier, mounted in the measuring cavity, with one or more electrodes, which in connection with electrodes on the inner wall of the measuring cavity, forms measuring capacitances.

The preferably solid ends of the flexible tube are preferably tied together through beams, flexible mainly in the direction of the force to be measured, which forces the flexible tube to be deformed in a S shape when the measured force is applied to the dynamometer and which also makes the dynamometer substantially insensitive to torsion and to forces from all other directions than the direction of the measurement.

By this design according to the invention a range of advantages are obtained.

The design of the flexible elastic tube with a relatively low height gives, in combination with a certain length, a high flexibility with large displacements of the inner wall of the measuring cavity, and as these displacements are substantially at a right angle to the surface of the electrodes and substantially parallel to the direction of the measured force the important advantage is obtained that a very high proportion of the deflection of the measuring device is transformed in a displacement to be measured by the measuring capacitances.

An important advantage of the invention is that errors from thermal expansion due to differences in coefficients of thermal expansion of the elastic body and the electrode carrier are reduced because of the relatively small dimensions of the measuring cavity in the direction of displacements from the measured force, while at the same time a rather large difference of the thermal expansions of the electrode carrier and the flexible tube, because of their appreciable length, does not give measuring errors as this expansion takes place at a right angle to the direction of displacements used in the measurement.

The mounting of the electrode carrier in the measuring cavity is according to the invention performed by at least one support along the length of the electrode carrier.

The mounting of the electrode carrier in the measuring cavity is advantageously and according to the invention done by supports at both ends or at some distance from both ends of the flexible tube, whereby a high mechanical stability is obtained.

When the electrodes are positioned on the electrode carrier at positions opposite the inner wall of the flexible tube then, because the flexible tube is deformed in a S shape, the relative displacements are differential and changing sign along the length of the electrode carrier.

When the supports for the electrode carrier are designed to permit an angular movement of the electrode carrier relative to the solid ends, the electrode carrier is not bent and this way the differential displacements of the tube along its length and relative to the electrode carrier are according to the invention measured by placing electrodes acting as differential capacitors along the length of the electrode carrier at one or both sides.

By arranging electrodes at positions where the distance to the inner surface of the flexible tube is increasing and also where it is decreasing at maximum rate, when the force is applied, it is possible to obtain a high measuring signal which rejects the errors from parallel shifts of the electrode carrier and when additionally electrodes are placed where there is substantially no deformation it is also possible to get a rejection of errors from angular shifts of the electrode carrier in the cavity.

When the supports for the electrode carrier for stability reasons are designed to permit only a limited angular movement of the electrode carrier relative to the solid ends, the electrode carrier is partly bent and this way the differential displacements of the tube along its length and relative to the electrode carrier are different compared to the situation when the electrode carriers permit free angular movements.

When in another embodiment of the invention, the electrode carrier is mounted fixed at one end of the measuring cavity the measurement is performed by the changes of the capacitances formed between electrodes on the inner wall of the measuring cavity and electrodes positioned at the electrode carrier an appreciable distance from the mounting end of the electrode carrier.

A differential capacitor may preferably be implemented by corresponding electrodes on both the upper and the lower side of the electrode carrier.

In this embodiment the displacement of the inner wall of the cavity, relative to the measuring electrodes is large, which results in a high sensitivity, but errors resulting from angular movements of the electrode carrier at the mounting end may also be high.

The errors due to angular movements of the electrode carrier may however be compensated by electrodes placed near the fixed end of the electrode carrier, where the relative displacement from the force to be measured is lowest, in connection with calculations performed by the capacitance measuring circuit.

In a preferred embodiment of the invention the electrode carrier is formed by using a part of the material of the elastic body as the material for the electrode carrier, and it is preferably formed by the same machining process which forms the cavity of the elastic tube and it is preferably done in such a way that some of this material is left untouched to perform the function of supporting the electrode carrier in the cavity.

By this embodiment of the invention the stability of the electrode carrier is the highest possible.

Extensions of the preferably solid ends of the flexible tube gives the possibility to close the measuring cavity with solid covers which may be mounted at the ends without interfering with the deformations of the flexible tube.

The invention will now be described in further detail with reference to the drawing in which

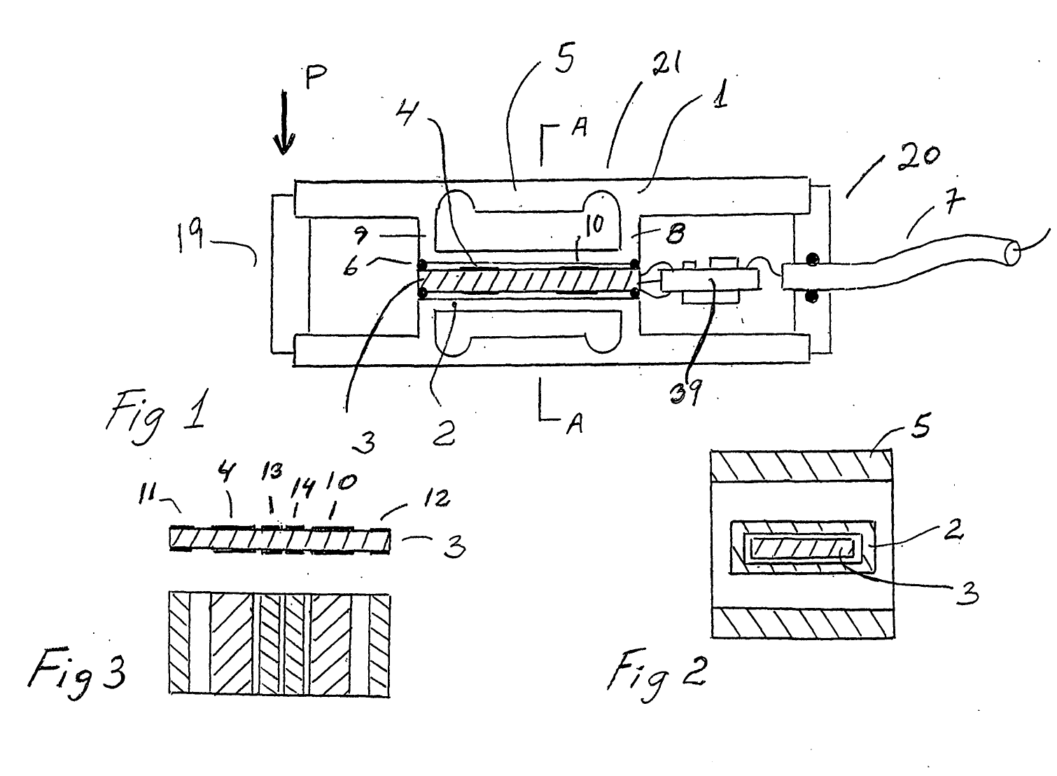

FIG. 1 illustrates an embodiment of a capacitive dynamometer according to the invention with the electrode carrier supported at both ends,

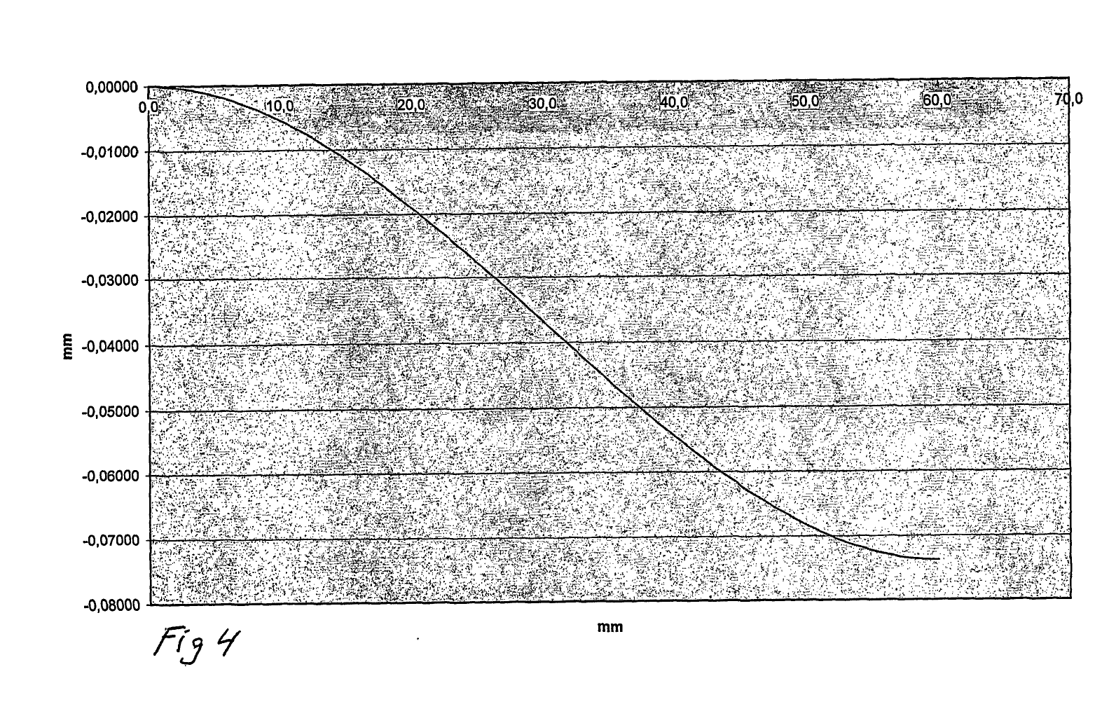

FIG. 2 is a cross section at A-A of the capacitive dynamometer on FIG. 1,

FIG. 3 is a top and side view of an electrode carrier with sets of measuring and compensation electrodes on both sides,

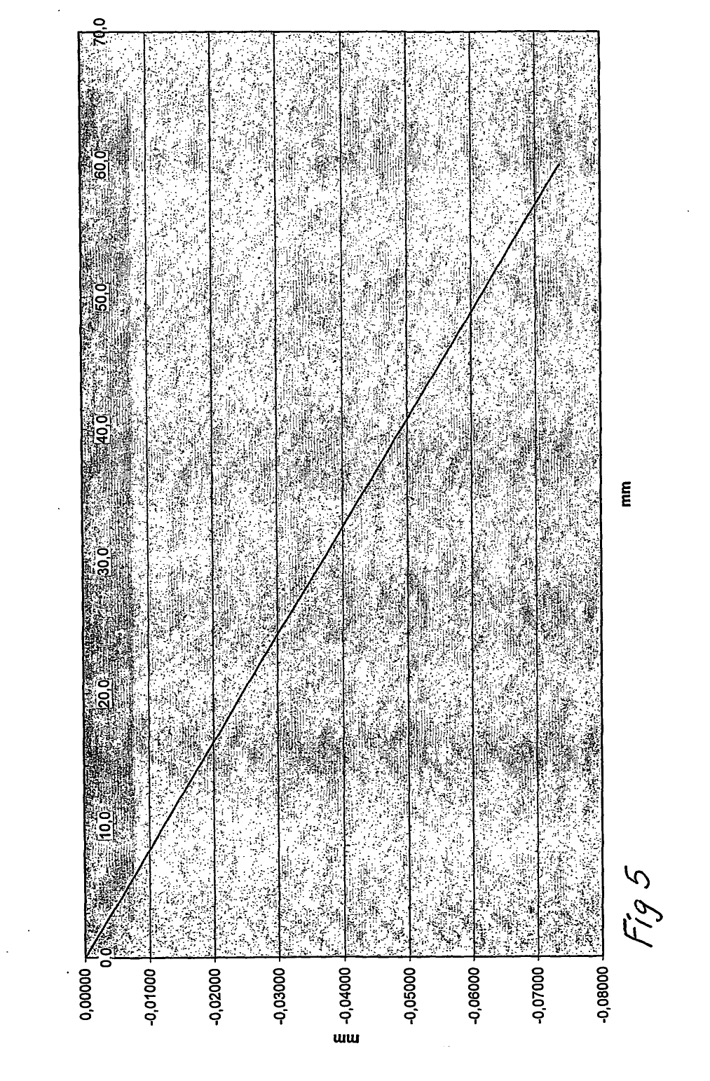

FIG. 4 is the deflection, caused by the force to be measured, of the inner wall of the flexible tube relative to the fixed solid end of the flexible tube,

FIG. 5 is the deflection of the electrode carrier supported at both ends in the cavity, and

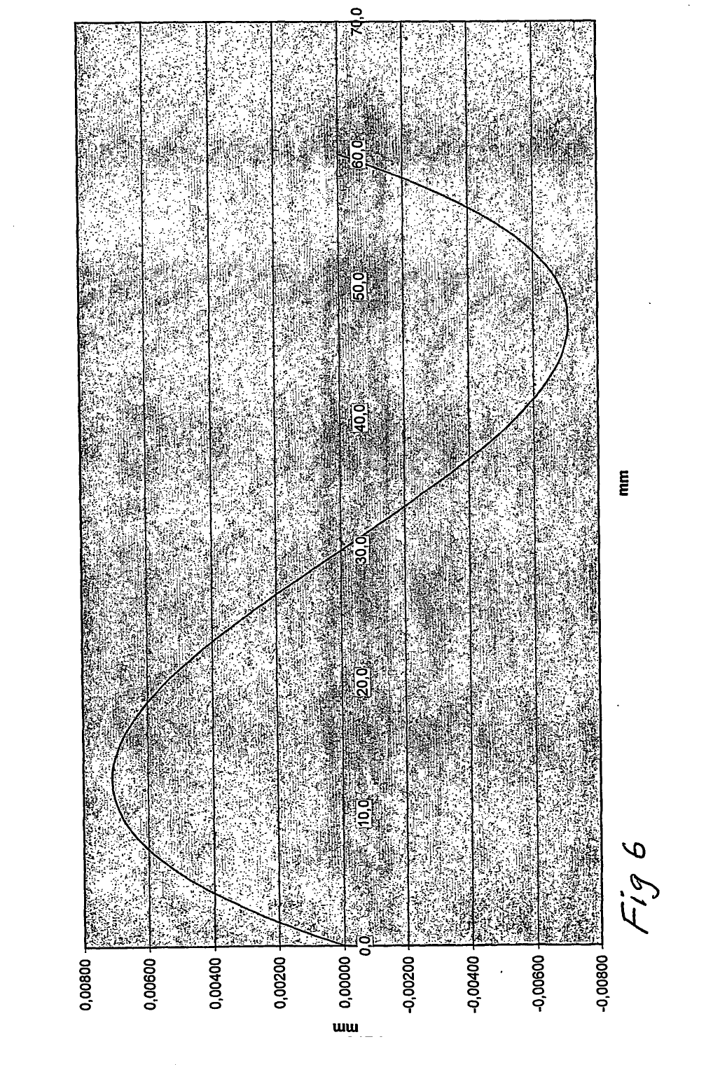

FIG. 6 is the difference between the deflection in FIG. 4 and the deflection in FIG. 5 i.e. the displacement of the inner wall of the flexible tube relative to the electrode carrier.

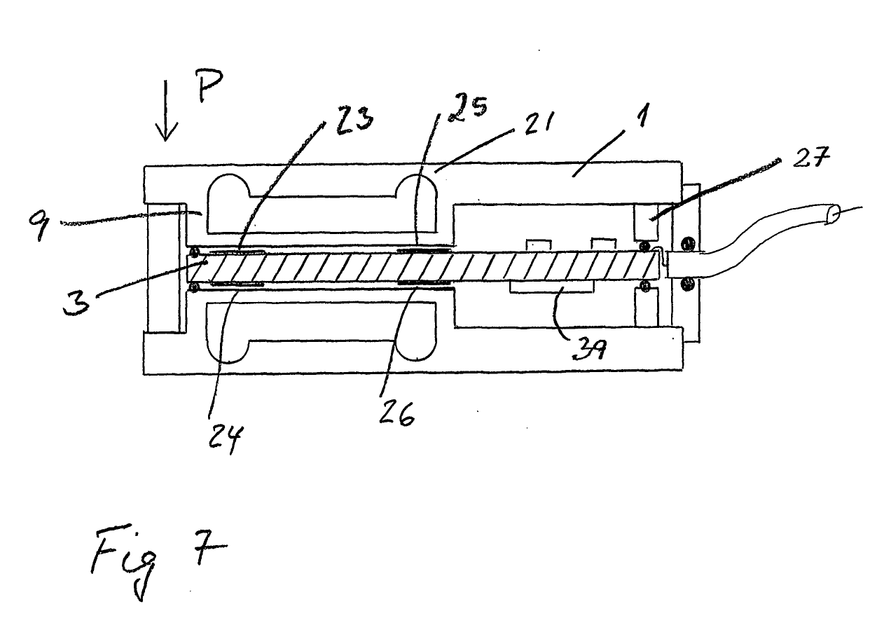

FIG. 7 is a preferred embodiment of a capacitive dynamometer according to the invention with the electrode carrier supported at both ends, and with one of the supports placed in the cavity of one of the extensions of the solid ends, at a distance from one end of the flexible tube.

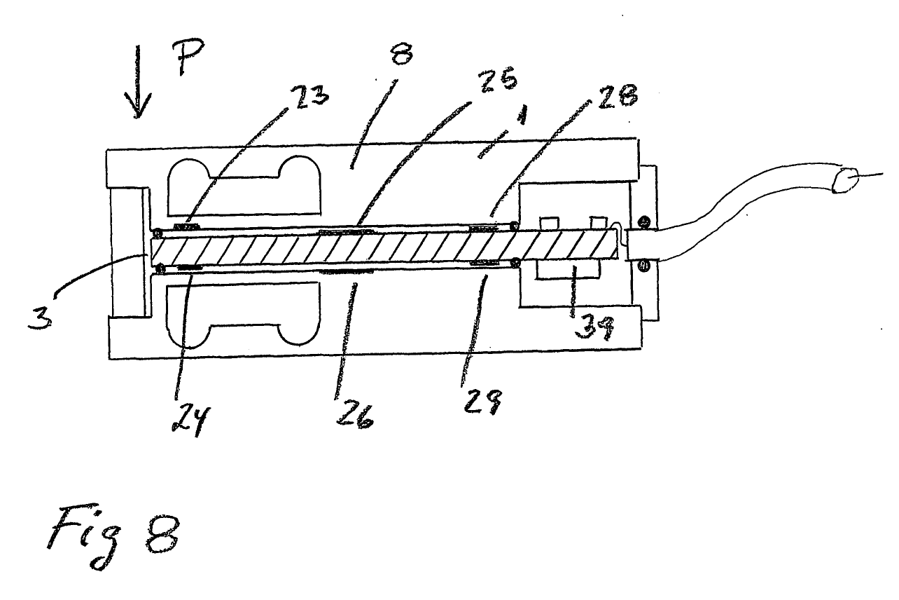

FIG. 8 is another preferred embodiment of a capacitive dynamometer according to the invention with the electrode carrier supported at both ends, and with one of the supports placed in the solid end of the flexible tube at a distance from the flexing part.

FIG. 9 is a preferred embodiment of a capacitive dynamometer according to the invention with the electrode carrier mounted fixed at one end of the flexible tube.

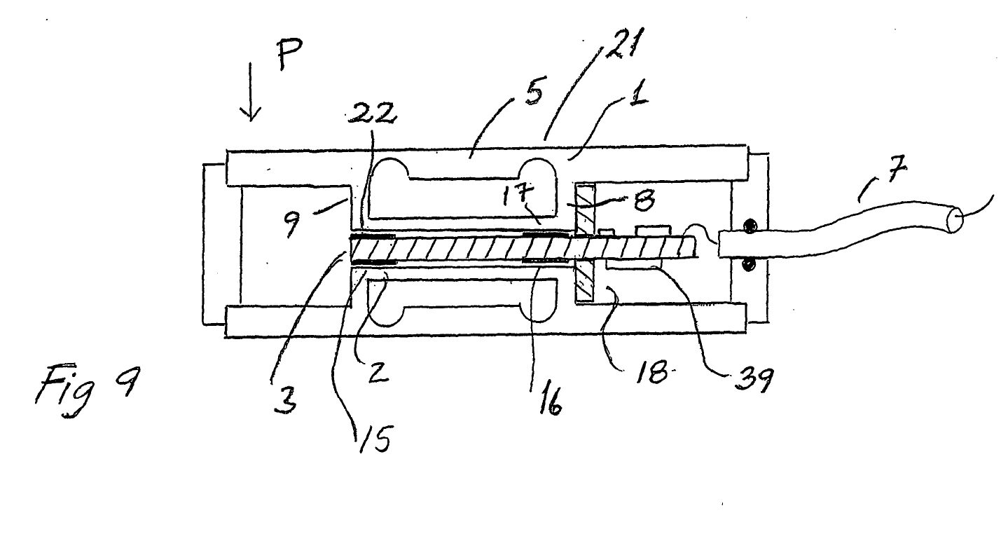

FIG. 10 is another preferred embodiment of a capacitive dynamometer according to the invention with the electrode carrier mounted fixed at one end of the flexible tube, and with the electrode carrier machined from a part of the material of the elastic body and consisting a part of this body.

FIG. 11 is a cross section at A-A of FIG. 10.

FIG. 12 is a cross section at B-B of FIG. 10.

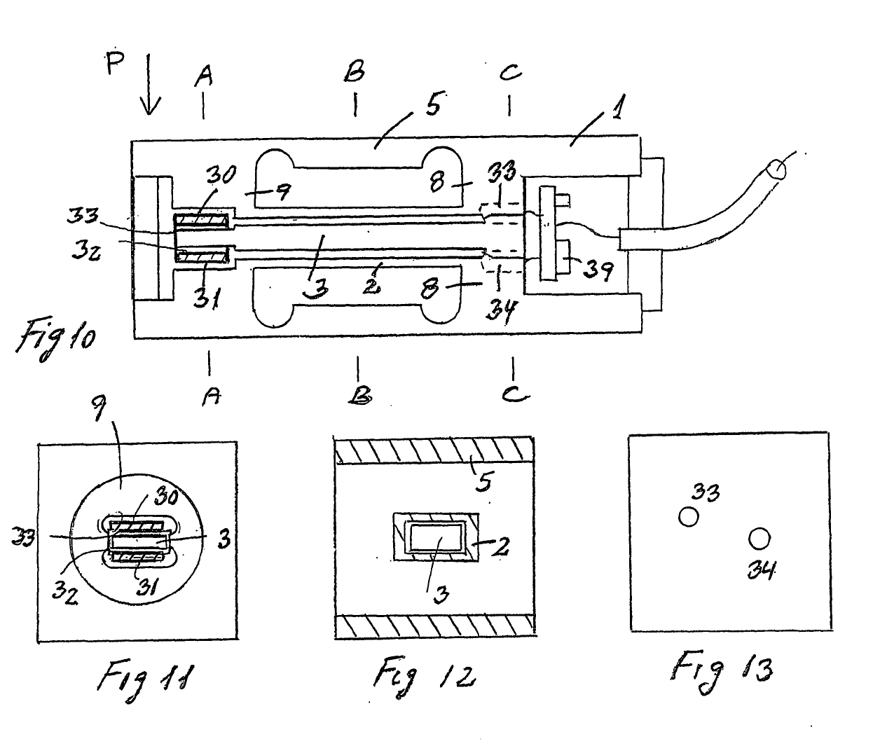

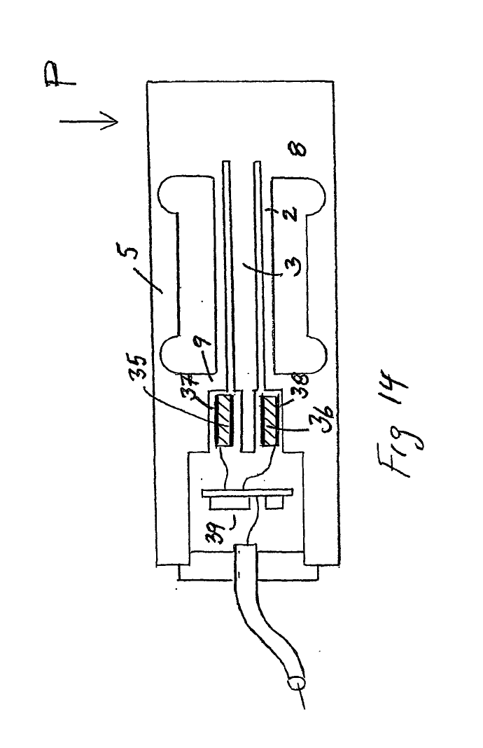

FIG. 13 is a cross section at C-C of FIG. 10.

FIG. 14 is another preferred embodiment of a capacitive dynamometer according to the invention with the electrode carrier mounted fixed at one end of the flexible tube, and with the electrode carrier machined from a part of the material of the elastic body and consisting a part of this body, and with measuring electrodes mounted fixed in the measuring cavity and the electrode carrier acting as the moving grounded counter electrode.

FIG. 1 is a side view of a preferred embodiment of the invention, showing the elastic body 1 with a force to be measured P applied to one end and with the other end kept fixed at a right angle to P.

The elastic part in the form of the flexible tube 2 has the preferably solid ends 8 and 9.

The electrode carrier 3 with electrodes 4 and 10 is shown mounted in the measuring cavity.

The flexible beams 5, ties together the solid ends of the flexible tube, in order to prevent the solid end 9 making an angular movement, but instead forces it to be displaced parallel to the force P.

The combination of the beams and the solid ends is necessary for the flexible tube to deform in the S shape which again is a prerequisite for the function of the capacitive dynamometer according to FIG. 1.

The beams are flexible because they have thinner cross sections 21 in order to concentrate their deflection at the ends.

The O-rings 6 are shown as an example of supports which keeps the electrode carrier in a fixed position preferably, but not necessarily, in the middle of the cavity of the elastic tube, as shown in FIG. 2, but at the same time allows the ends of the electrode carrier to turn freely in relation to the solid ends.

A further advantage by the O-rings 6 is their ability to seal the cavity.

The preferably solid ends 8 and 9 have extensions, which may be closed by solid covers 19 and 20, without interfering with the deformation of the flexible tube.

A capacitance measuring circuit 39, which is shown connected to the signal cable 7 and to a number of measuring and compensating electrodes on the electrode carrier 3, is placed in the extension of the solid end 8.

When a force P is applied to the elastic body 1 a displacement of the flexible tube 2 and the beams 5, proportional to the force P, and depending on the dimensions of foremost the flexible tube, will take place.

A calculation of the displacement of a flexible tube 2, with the height 6 mm, cavity height 4 mm, width 25 mm, length 60 mm and force 100 N, is shown in FIG. 4 where the deflection in mm is shown on the y axis and the distance in mm along the length of the flexible tube is shown on the x axis.

The tube is here mounted fixed at the left end and loaded at the right end.

The ends of the electrode carrier 3 will follow the ends of the flexible tube and because the ends of the electrode carrier may turn freely in their supports in the solid ends of the flexible tube the electrode carrier will not be bent and the displacement of the inner wall relative to the electrode carrier will be as shown in FIG. 6 for the lower side of the electrode carrier.

A similar figure for the upper side of the electrode carrier will show the same displacements, but with opposite signs.

With the measuring electrodes arranged, as shown in FIG. 3, on one or preferably on both sides of the electrode carrier, and with electrode 4 in a location with the minimum and electrode 10 in a location with the maximum distance when the dynamometer is loaded, a differential signal is obtained which is seen to be compensated for errors due to a parallel shift of the electrode carrier in the cavity.

When electrodes are mounted in the corresponding places on the lower side of the electrode carrier a differential signal may likewise be obtained but with reversed polarities.

The function of the compensating electrodes 11, 12, 13 and 14 is to compensate errors due to angular shifts and bending of the electrode carrier in the cavity, by suitable choice of positions and areas for these electrodes.

When the electrodes 11 and 13 for example are coupled together and coupled differentially in relation to the measuring electrode 4 it is possible to fully compensate angular movements of the electrode carrier caused by movements up or down of one of the supports.

When the measuring electrode 4, according to the invention, is placed in a position with maximum relative displacement of the inner wall and the compensating electrodes 11 and 13 are placed at positions with minimum displacements, a high resulting signal may be obtained.

Likewise, the measuring electrode 10, may be compensated by the electrodes 12 and 14 and if measuring electrodes are mounted on the lower side of the electrode carrier corresponding compensating electrodes may be utilized the same way.

In a preferred embodiment the electrode carrier may also be supported at the middle where according to FIG. 6 the relative displacement is zero.

In FIG. 7 another embodiment of the invention is shown, where the mounting of one end of the electrode carrier 3 is made at a distance from the flexible tube 2 at the support 27, which here is mounted at the extension of the solid end 8. When a force P is applied to the dynamometer at the left end and the other end is fixed, the left end of the electrode carrier 3, which is supported at both ends in a way where an angular movement is permitted, will substantially have the same displacement as the solid end 9 while the other end of the electrode carrier will substantially have no displacement.

When electrodes 25 and 26 are positioned on the electrode carrier near the right end of the flexible tube they are positioned where the differential change of distance to the inner wall of the flexible tube may be high as it is the displacement due to the force P multiplied by the ratio of the distance from the left support to the position of the electrodes 25 and 26 to the distance between the supports. These changes of distance from the electrodes 25 and 26 to the inner wall of the measuring cavity are seen to be differential.

The electrodes 23 and 24 are mounted in positions on the electrode carrier where the change of distance to the inner wall of the flexible tube is small and they may therefore be used as reference capacitors for the compensation of effects due to changing temperatures etc.

In FIG. 7 the capacitance measuring circuit 39 is shown mounted on the electrode carrier, but it may according to the invention instead be mounted separately anywhere in one of the extensions of the solid ends.

In FIG. 8, another preferred embodiment of the invention with substantially the same design as the dynamometer according to FIG. 7, but with one end of the electrode carrier 3, mounted at the lengthened solid end 8 of the flexible tube 2, providing the advantage of a very stable mounting, directly in the measuring cavity.

Here the electrodes 25 and 26 again are placed in positions with large differential changes of distance to the inner wall of the measuring cavity when the dynamometer is measuring the force P.

In this embodiment of the invention it is also possible to compensate errors from movements of the electrode carrier in the measuring cavity by sets of reference electrodes 23, 24 and 28 and 29.

In FIG. 9 an embodiment of the invention is shown where the electrode carrier 3 is mounted at the solid end 8 of the flexible tube 2 by the dimensionally stable mounting bracket 18.

The differentially coupled electrodes 22 and 15 measures the deflection of the flexible tube at or near the solid end 9, which has a rather large deflection as shown in FIG. 4.

This embodiment of the invention is seen to be sensitive to angular movements of the electrode carrier relative to the solid end 8, but the compensating electrodes 16 and 17, placed in positions with low displacements from the force to be measured, will predominantly sense only this angular movement and may in connection with calculations performed by the capacitance measuring circuit compensate the errors from the angular movements.

An embodiment of the capacitive dynamometer according to FIG. 9, without the beams 5, will be sensitive to the method of application of the force P, but may be produced at a very low cost.

This embodiment of the invention is advantageous in applications with high demands on sensitivity, but with an environment with low vibrations and stable temperatures.

According to the invention the electrode carrier may, as shown in FIG. 9, be extended outside the measuring cavity with the capacitance measuring circuit 39 for the measurement of the capacitances mounted on the extension with the advantage that a complete measuring unit may simply be inserted into the cavity of the elastic body to obtain the lowest possible assembly costs.

The electrode carrier may advantageously be made of a dimensionally stable insulating material such as ceramic or glass-ceramic materials with electrodes deposited on the surface by for example thick- or thin film techniques or the electrode carrier may be made of metal or of a metal with an insulating layer as the basis for depositing the electrodes, but other methods of producing the electrodes may be used according to the invention.

As an example, for low-cost versions of the capacitive dynamometer, the electrode carrier may by printed circuit material where the electrodes are etched on the base material.

The electrode carrier may advantageously also be produced by sandwiching a stiffening layer of insulating or non insulating material between two electrode carriers with the measuring electrodes deposited on the outer side and the interconnections to the capacitance measuring circuit or the measuring circuit itself mounted on the inner side of the electrode carriers or between these.

In another embodiment of the invention the electrode carrier is made of a relatively thick material and here the interconnections may advantageously be placed on the side of the electrode carrier in order not to interfere with the measurement.

In FIG. 10 is shown an embodiment of the invention, with the electrode carrier 3, machined from the base material of the elastic body 1, with one end of the electrode carrier still attached to the base material, while the free end carries the electrodes 30 and 31 which measures the differential changes of distance to the inner wall of the measuring cavity when the dynamometer measures the force P. The preferred method of machining is spark erosion machining which gives a limited distortion of the material, which again gives a very high stability of the electrode carrier in the measuring cavity which here is a part of the solid end 9.

The electrodes 30 and 31 may advantageously be mounted on insulators which are fixed in relation to the electrode carrier 3 in a way to permit the mounting of the reference electrodes 32 and 33.

These electrodes will basically see no change of distance in the normal operation of the dynamometer, but may be connected to compensate displacements of the insulators carrying the measuring electrodes 30 and 31 in relation to the electrode carrier 3.

The electrodes 30 and 33 may be connected together or they may simply constitute the upper and the lower surface of an electrode produced from an electrically conducting material, the same applies of course for electrodes 31 and 32.

FIG. 11 is a cross section of the dynamometer at A-A showing the end of the electrode carrier 3 with the electrodes 30 and 31 positioned in the measuring cavity, machined in the solid end 9.

FIG. 12 is a cross section at B-B of the dynamometer showing the electrode carrier 3 in the flexible tube 2 and the beams 5.

FIG. 13 is a cross section at C-C, showing holes 33 and 34 drilled through the solid end 8 where the electrode carrier is fixed in the base material of the elastic body.

The function of the holes is to conduct the signals from the electrodes 30, 31 and 32, 33 to the capacitance measuring circuit 39.

While the process of machining the electrode carrier from the base material of the dynamometer gives the highest stability it is according to the invention possible to mount a separately machined electrode carrier as shown in FIG. 9 in a number of ways, as for example by directly laser welding the electrode carrier 3 into the solid end 8, thereby obtaining the same function as in FIG. 10, but with less stability and at a lower cost.

An advantage of the dynamometer according to the invention and as shown in FIGS. 9 and 10 is that shock loads from the force P are only sensed by the robust elastic body 1 with the flexible tube 2 and the beams 5, because the electrode carrier 3 with the electrodes and the capacitance measuring circuit 12 are referenced to the fixed solid end of the dynamometer.

In FIG. 14 a dynamometer according to the invention is shown where the function of the electrode carrier 3 is to act as the grounded moving electrode while the electrodes 35 and 36, which are fixed in the measuring cavity, machined in the solid end 9, differentially measures the displacement of the electrode carrier 3. Reference electrodes 37 and 38 may compensate displacements, due to temperature changes, of the insulators of electrodes 35 and 36 relative to the measuring cavity in the same way as in the dynamometer according to FIG. 10. The electrodes 35 and 37 may be connected together or they may simply constitute the upper and the lower surface of an electrode produced from an electrically conducting material, the same applies of course for electrodes 36 and 38.

This dynamometer according to the invention has the same advantages as the dynamometers according to FIGS. 9 and 10, but with a simpler connection from the electrodes to the measuring circuit 39.

The electrode carrier 3 may be made stiff enough to place its frequency of resonance above the frequencies introduced by the force P.

Due to the fact that preferred embodiments of the invention have been illustrated and described herein, it will be apparent to those skilled in the art that modifications and improvements may be made to forms herein specifically disclosed.

Accordingly, the present invention, which basically consists of two solid ends connected by a flexible tube, each solid end containing a part of a displacement measuring system, is not to be limited to the forms specifically disclosed.

For example the measuring electrodes measuring the displacements, due to the force to be measured, of one of the solid ends in relation to the other solid end, may in all embodiments of the dynamometer according to the invention be placed fixed either on the electrode carrier or fixed in the measuring cavity.

Correspondingly the counter electrode, which normally, but not necessarily is grounded, may either be placed in the measuring cavity or on the electrode carrier, or the electrode carrier itself could form the electrode.

Likewise the part which is displaced due to the force to be measured may be the measuring cavity or the electrode carrier.

As another example, insulated electrodes could be placed both on the electrode carrier and in the measuring cavity in a measuring device according to the invention.

Furthermore for example the cross section of the flexible tube may according to the invention be oval or round, square or rectangular or alternatively have a cavity with a cross section with rounded ends.

Also the disclosed capacitive method of measuring the changes of displacements may be substituted by other displacement measuring methods, for example eddy current measurements where the capacitive electrodes are simply substituted by small coils.

1. A measuring device for measuring a mechanical force, said measuring device including an elastic body for receiving the mechanical force to be measured, said elastic body having a measuring cavity adapted for being deformed when the mechanical force to be measured is applied to the elastic body, said device including measuring means for measuring the deformation of said measuring cavity, characterized in that
said elastic body includes a flexible tube having a length which is substantially larger than the height of said tube, said tube having solid ends, and said measuring means, adapted for measuring a displacement between said solid ends of said flexible tube, utilizing a cavity of said flexible tube adapted to performing or transferring the displacement measurement.

2. A measuring device according to claim 1, characterized in that said cavity of said flexible tube forms said measuring cavity.

3. A measuring device according to claim 1 or 2, characterized in that one or more of said solid ends include the measuring cavity.

4. A measuring device according to one or more of claims 1-3, characterized by including an extension of at least one said solid ends, said one or more extensions include the measuring cavity.

5. A measuring device according to one or more of claims 1-4, characterized in that said measuring means including an elongated electrode carrier mounted in said measuring cavity

6. A measuring device according to one or more of claims 1-5, characterized in that said measuring means including one or more measuring electrodes adapted for measuring a displacement between said electrode carrier and an inner wall of said cavity.

7. A measuring device according to one or more of claims 1-6, characterized by including supporting means adapted for supporting said electrode carrier in said measuring device, said supporting means including a first supporting member being located in the flexible tube.

8. A measuring device according to one or more of claims 1-7, characterized by including supporting means adapted for supporting said electrode carrier in said measuring device, said supporting means including a second supporting member being located in one or more of the solid ends.

9. A measuring device according to one or more of claims 1-8, characterized by including supporting means adapted for supporting said electrode carrier in said measuring device, said supporting means including a third supporting member being located in one or more of the extensions of the solid ends.

10. A measuring device according to one or more of claims 1-9, characterized in that one of said first, second and third supporting means forms a fixed support of said electrode carrier in said measuring device.

11. A measuring device according to one or more of the preceding claims, characterized in that said measuring means include capacitive and/or inductive electrodes.

12. A measuring device according to one or more of the preceding claims, characterized in that said one or more extensions of the said preferably solid ends of the flexible tube, include a solid cover to engage with said extension.

13. A measuring device according to one or more of the preceding claims, characterized in that said preferably solid ends of the flexible tube are tied together through beams, flexible mainly in the direction of the force to be measured.
